(19) United States
(12) Patent Application Publication
(10) Pub. No.: US 2007/0234319 A1
(43) Pub. Date: Oct. 4, 2007

(54) Software maintenance supporting program product, processing method and apparatus

(75) Inventors: Takahide Matsutsuka, Kawasaki (JP); Kuniharu Takayama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/475,966

(22) Filed: Jun. 28, 2006

(30) Foreign Application Priority Data
Mar. 29, 2006 (JP) 2006-90088

(51) Int. Cl. G06F 9/45; G06F 9/44

(52) U.S. Cl. 717/140; 717/104

(57) ABSTRACT

A source structure obtaining unit of the apparatus analyzes a source code with an annotation, renders elements and associates as an object, generates a model representing a structure of the source code 5 and stores the model in a source code object storing unit. An architecture structure obtaining unit generates a model of architecture information which is rendered as an object and stores the model in an architecture object storing unit. Then, a gap analyzing unit compares said two models and outputs unassociated objects as gap information. A pattern matching unit compares the model of the source code object storing unit with bad pattern information of a bad pattern information storing unit and outputs the corresponding object as detected badness information.

### CROSS-REFERENCE TO RELATED APPLICATIONS

This application claims priority from Japanese patent application Serial no. 2006-090088 filed Mar. 29, 2006, the contents of which are incorporated by reference herein.

### BACKGROUND OF THE INVENTION

1. Field of the Invention

The present invention relates to a software maintenance supporting program product and a processing method for supporting maintenance of a software program whose source code is subject to change. More specifically, the present invention relates to a data processing technique for detecting deviation of a structure represented by a software program which is subject to change in maintenance operation based on architecture information on the software specification design material and providing the detected information.

2. Description of the Related Art

A computer system or a software program is used for a long period of time, being subject to a number of changes. In order to keep the load of maintenance and changing operation on the software program from increasing, software functionality need to be corrected or expanded, for example, according to architecture specified in the specification when a software program is changed.

As a conventional method, a method for examining contradiction in a usage of a software function by using the change state model of a software program and detecting errors in the function occurred in changing of the software program, when the software program specification is created or changed (for example, see Patent Document 1: Japanese Patent Laid-Open No. 5-334125).

In the actual maintenance operation of a software program, it is often the case that only a source code of the software program is changed or added without architecture of the specification being referenced to. When a source code is changed first, operation for reflecting the change on the architecture information to be saved in the form of specification is often done later. There is sometimes a case where revision operation on the architecture information associated with a change in the source code is not done. As a result, the problem may occur in that a structure defined in the design in the architecture information and a structure of a software program realized by an actual source code are not associated with each other. However, a method for detecting whether or not an actual software program structure is changed from architecture information has not been developed yet. Thus, how much a software program structure with functions added or expanded due to change of its source code is differed from the initial architecture of a specification could not be known.

In an actual maintenance operation, change of a source code starts first and materials to be saved in data in the other forms such as a specification or an amendment to a specification starts later. As a result, operation of associating the architecture information to the change is frequently postponed. That has caused a problem in that deviation of a software program structure with many changes from an initial architecture becomes common. Moreover, a problem has occurred in that a software program maintenance becomes worse when a source code is changed in a condition that a correlation cannot be taken. Such a condition might make a software program more complex and cumbersome. It has also been a problem in that an inappropriate software program structure may be included in change of its source code.

### SUMMARY OF THE INVENTION

An object of the invention is to provide a data processing technique for detecting a part where a structure determined from a software source code and a structure defined by architecture information of the specification material cannot be associated with each other in order to support maintenance operation of the software program with changing operation on the source code.

Another object of the invention is to provide a data processing technique for detecting an inappropriate element which should be avoided from the software program.

The present invention is for supporting software maintenance by detecting how much gap is present between a software program structure and architecture defined in its specification as a source code of the software is changed. The present invention is also for supporting software maintenance by detecting whether a changed software program includes an element or a configuration which is considered inappropriate such as so-called “Bad Practice Rules”.

The present invention is a program product for causing a computer to execute processing below for supporting software maintenance operation. A computer that executes the present invention obtains a source code with a predetermined annotation (comment) indicating elements comprising the software program to be processed and extracts elements and associates indicating association between the elements from the source code. Then, the computer generates and keeps a source code structure model indicating said source code structure according to predetermined modeling representation based on the extracted elements and associates. The annotation is a description in a source code and a part which does not influence operation of a program.

The computer further obtains architecture information defining a software program structure as a specification of said software program and generates and keeps an architecture model that indicates a structure that is defined in the architecture information according to predetermined modeling representation based on the obtained architecture information. Then, the computer compares elements (elements or associates) respectively comprising the source code structure model and the architecture model and detects elements that are not associated with each other between the models. The computer also outputs gap information on the detected elements. Here, representation compliant with the UML (Unified Modeling Language) can be used as modeling representation. That enables a user to recognize whether a deviation is present between a structure of the source code of the software program and a structure defined in its specification (architecture information) or not.

Further, a computer that executes the present invention obtains bad pattern information indicating elements or associates inappropriate for a source code of a software program. The computer also obtains a source code with a predetermined annotation which designates elements comprised in the software program and extracts elements and associates indicating association between said elements from the source code. Then, the computer generates and maintains a source code structure model indicating a structure of said source code according to predetermined modeling representation based on the extracted elements and associates. The computer compares the source code structure model and the bad pattern information, determines whether the elements or the associates of the source code structure model correspond to elements of the bad pattern information or not, and detects corresponding elements or corresponding associates. The computer outputs information on the corresponding elements as detected badness information. The detected badness information is information on a bad pattern which represents inappropriate parts that should be avoided as a software configuration by elements and associates. That enables a user to recognize whether inappropriate configuration is included in the source code of the software program or not.

The present invention is a processing method for a computer to execute processing to be executed by the abovementioned program. The present invention is a processing apparatus consisting of processing means which executes processing executed by the abovementioned program.

The present invention can detect a gap between a structure extracted from architecture information of a software program and a structure extracted from a source code by comparing the structures. That solves a problem in that an actual structure of a software program is departing from a structure defined in an original specification as a source code is changed, even if the structures were synchronized with each other at the beginning of designing. For example, a user can check whether a structure of a software program which changed gap information by change of a source code deviates from its initial architecture or not. A user can also check whether a necessary change on the software program requires the architecture itself to be changed or not.

The present invention can detect whether a software program structure includes a bad pattern representing inappropriate elements or inappropriate configuration or not. Thus, the present invention can prevent inappropriate cording from slipping into a source code or can correct an inappropriate part already included in the source code when maintenance operation such as changing or adding of the source code is done. Therefore, in repeatedly changed software programs, association between the structure and the architecture can be taken and an appropriate configuration can be maintained. That is expected to prevent the load of maintenance operation from increasing or a software program or a maintenance material from being cumbersome.

### BRIEF DESCRIPTION OF THE DRAWINGS

FIG. 1 is a diagram showing an exemplary configuration in an embodiment of the present invention:

FIG. 2 is a diagram showing exemplary representation of an architecture model.

FIGS. 3A, 3B, 4A and 4B are diagrams for illustrating processing of analyzing a gap between a structure and an architecture of a software program:

FIGS. 5A and 5B are diagrams for illustrating processing of matching a source code with bad pattern information:

FIG. 6 is a processing flow of main processing of the present invention:

FIG. 7 is a processing flow of annotation analyzing processing of the present invention:

FIG. 8 is a processing flow of rendering as an object processing of the presenting invention:

FIG. 9 is a processing flow of matching for analyzing a gap against architecture information of the present invention:

FIG. 10 is a flow processing of matching for matching a pattern against bad pattern information:

FIG. 11 is a diagram showing an example of a comment part extracted from a source code:

FIG. 12 is a diagram showing an example of a source code structure model represented by a node object and a link object: and

FIG. 13 is a diagram showing an example of an architecture model.

### DETAILED DESCRIPTION OF THE PREFERRED EMBODIMENTS

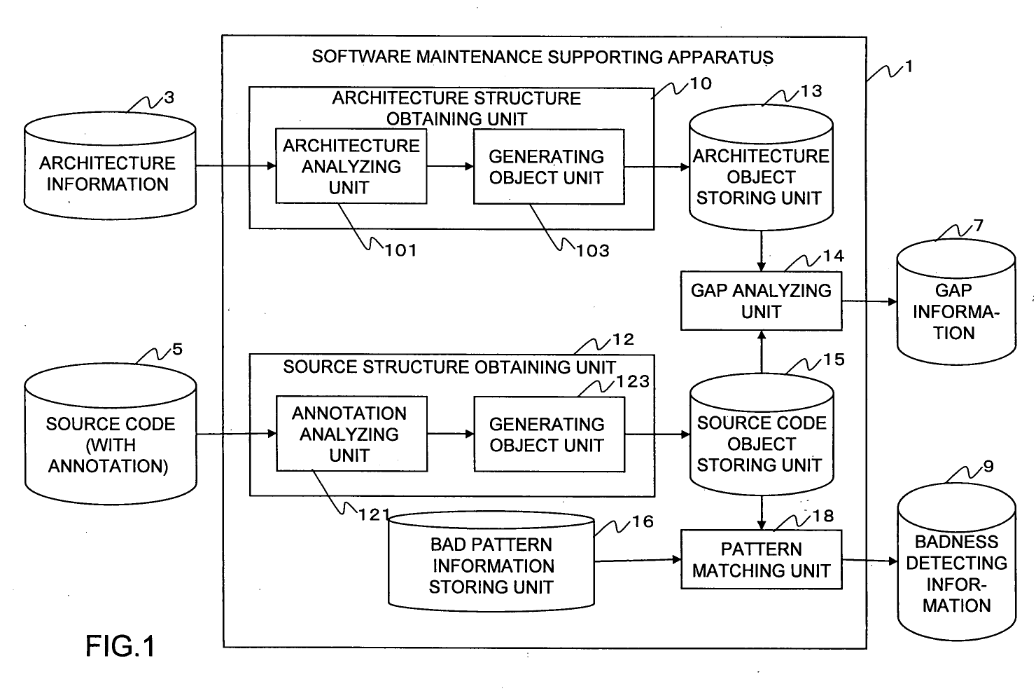

FIG. 1 is a diagram showing an exemplary configuration in an embodiment of the present invention. A software maintenance supporting apparatus 1 is an apparatus for providing information for supporting maintenance operation of a software program which is subject to repeated change. The software maintenance supporting apparatus 1 has an architecture structure obtaining unit 10, a source structure obtaining unit 12, an architecture object storing unit 13, a gap analyzing unit 14, a source code object storing unit 15, a bad pattern information storing unit 16 and a pattern matching unit 18.

The architecture structure obtaining unit 10 is processing means for obtaining a structure model (architecture) based on predetermined modeling representation from architecture information 3 on a software program structure to be supported. The architecture structure obtaining unit 10 has an architecture analyzing unit 101 and a generating object unit 103.

The architecture information 3 is information representing a software program structure included in document data such as a specification of a software program. The architecture information 3 may be extracted from the document data by existing text analyzing processing or existing data extracting processing.

The architecture analyzing unit 101 is processing means for obtaining the architecture information 3, analyzing the obtained architecture information 3 and extracting software elements and association between the elements.

The generating object unit 103 is processing means for generating an architecture model 20 represented in predetermined modeling representation based on the software program elements and the association between the elements, and temporally keeping the architecture model 20 in the architecture object storing unit 13.

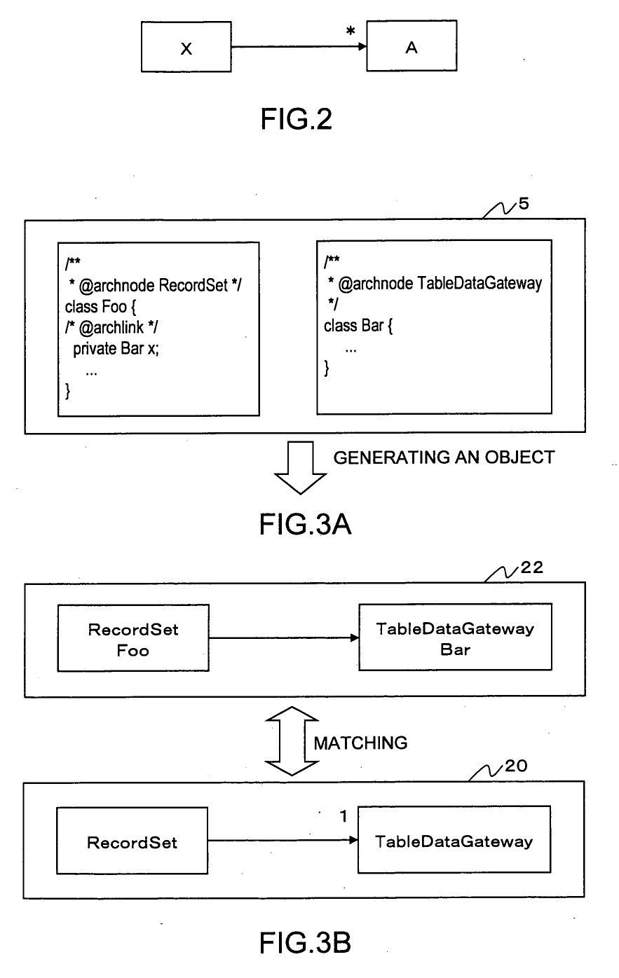

In the embodiment, representation complying with the UML is used as modeling representation of rendering as an object. As shown in FIG. 2, the architecture model 20 can be shown by a diagram corresponding to a class diagram of the UML. In FIG. 2, the reference characters X and A denote elements, each being represented as a class. An arrow from X to A represents associates from the class X to the class A, being represented as an association. The numbers of the elements or the associates are represented by cardinality (multiplicity) added to the association. In the exemplary representation of FIG. 2, one or more arbitrary elements “X” and a component “A” are present. Associates from the respective elements “X” represent that a plurality of elements are linking with a component “A”.

The source structure obtaining unit 12 is processing means for obtaining a structure model based on predetermined modeling representation from a source code of a software program to be supported. The source structure obtaining unit 12 has an annotation analyzing unit 121 and a generating object unit 123.

The annotation analyzing unit 121 is processing means for extracting elements comprising a software program (hereinafter referred to as “node object”) and associates indicating association between the elements (hereinafter referred to as “link object”) by analyzing a predetermined annotation added to a source code 5 of a software program. The annotation added to a source code is an object for creating a meaning of a program to a program element such as a class, a method or a field without influencing program operation. The annotation is represented as a declaration starting with “@” in Java (registered trademark of US Sun Microsystems, Inc.), for example. The annotation analyzing unit 121 detects a predetermined annotation from the source code 5, determines the type of elements (elements or associates) from the type of declaration of the annotation and extracts elements such as a class name, a field name and a method.

The generating object unit 123 is processing means for generating a source code structure model 22 indicating a software program structure by using the same modeling representation (UML) as that of the generating object unit 103 based on the extracted elements and associates, and temporally storing the source code structure model 22 into the source code object storing unit 15.

The gap analyzing unit 14 is processing means for comparing the source code structure model 22 and the architecture model 20, detecting either elements or associates that are not associated with a structure of its counterpart, and outputting the detected result as gap information 7.

The bad pattern information storing unit 16 is storing means for storing bad pattern information 24 representing an inappropriate structure which should be avoided as a software program structure. The bad pattern information 24 is what represents existing rules such as so-called “Bad Practice Rules” by using the abovementioned modeling representation. The bad pattern information 24 is prepared by a user beforehand.

The pattern matching unit 18 is processing means for matching the source code structure model 22 with the bad pattern information 24 to check whether the source code structure model 22 has a structure matching the bad pattern information 24 or not by referencing the bad pattern information storing unit 16, and outputting the matching result as detected badness information 9.

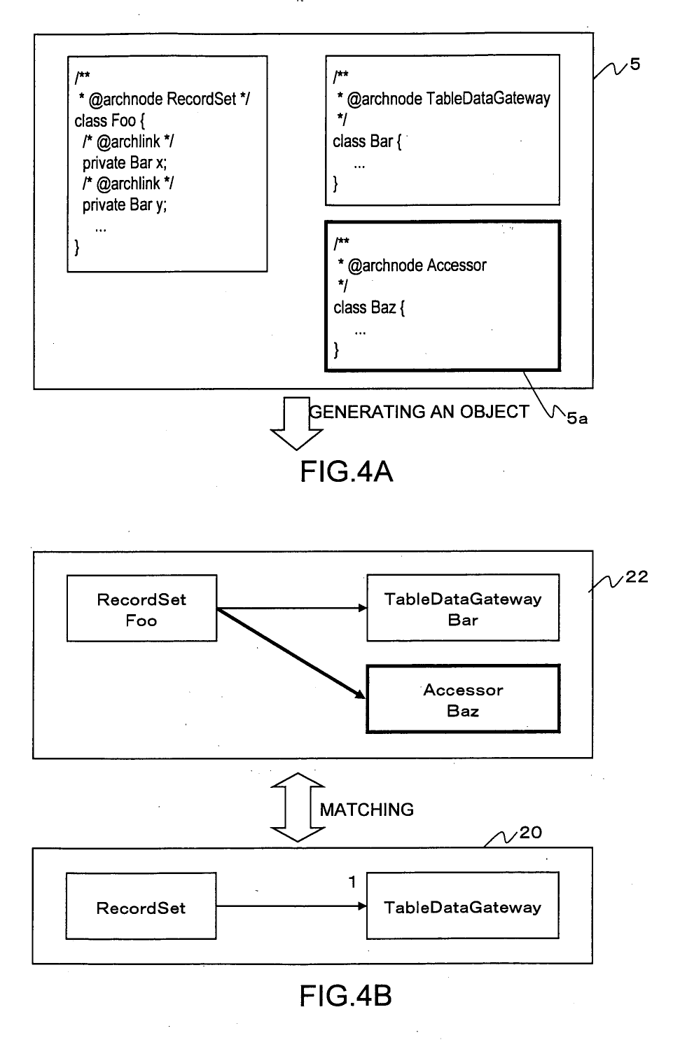

Analyzing of a gap between a structure and an architecture of a software program in the embodiment will be described by using FIGS. 3A and 3B and FIGS. 4A and 4B.

The annotation analyzing unit 121 searches the source code 5 to be processed shown in FIG. 3A for a predetermined annotation (comment) starting with “@”, determines the type of elements from the found annotation and extracts component information (value) such as a class name, a field name, a message name or a link destination. Here, “@archnode”, “@archlink” are assumed to be set as predetermined annotations. “@archnode” represents elements (nodes) comprising an architecture, and “@archlink” represents an associate indicating association between the elements comprising the architecture.

The annotation analyzing unit 121 stores the extracted data into an inside storage of the generating object unit 123 as arrangement data. Specifically, the annotation analyzing unit 121 detects “@archnode” of the annotation of the source code 5 shown in FIG. 3A, determines the type (node) of an element, and further extracts a class name (RecordSet) and a field name (Foo) which are component values of the element. The annotation analyzing unit 121 also detects “@archlink”, determines the type of an element, and extracts a link destination (Bar) as component information.

The generating object unit 123 generates the source code structure model 22 which is the structure of the source code 5 rendered as an object based on arrangement data with contents of the elements stored in an inside storage according to the modeling representation of the UML and stores the source code structure model 22 in the source code object storing unit 15. The architecture analyzing unit 101 analyzes the architecture information 3 and extracts elements and associates representing the architecture.

The generating object unit 103 generates the architecture model 20 which is a structure defined in an architecture rendered as an object based on the extracted elements and associates according to the modeling representation of the UML and stores the architecture model 20 in the architecture object storing unit 13.

The gap analyzing unit 14 retrieves the architecture model 20 in the architecture object storing unit 13 and the source code structure model 22 in the source code object storing unit 15 and compares them, detects whether an element which is not associated with its counterpart or not, and outputs the element which is not associated with its counterpart as the gap information 7. Here, the architecture model 20 and the source code structure model 22 as shown in FIG. 3B are assumed to be generated. The gap analyzing unit 14 compares elements or associates of respective models. As both elements is associated with each other and no gap is detected, the gap information 7 is not outputted. Alternatively, the gap information 7 indicating no gap is outputted.

It is assumed that maintenance operation involving improvement of the software program is executed, the source code 5 is changed and a new code part 5a is added as shown in FIG. 4A thereafter.

The annotation analyzing unit 121 detects predetermined annotations (comments) “@archnode”, “@archlink” of the source code 5 of FIG. 4A as in the processing on the source code 5 of FIG. 3(A) and extracts component information such as a class name, an object name and a link destination. Here, the annotation analyzing unit 121 detects a class (class name=Accessor), which is a new component (node), and extracts component information of the component.

The generating object unit 123 generates the source code structure model 22 shown in FIG. 4B based on arrangement data of storage as in the abovementioned processing and stores the source code structure model 22 in the source code object storing unit 15. If the architecture information 3 is not changed, the architecture model 20 same as that of FIG. 3B is stored in the architecture object storing unit 13 as shown in FIG. 4B.

The gap analyzing unit 14 retrieves the architecture model 20 in the architecture object storing unit 13 and the source code structure model 22 in the source code object storing unit 15 and compares them, detects whether elements which are not associated with its counterpart, and outputs the element which is not associated with its counterpart as the gap information 7. Here, the source code structure model 22 includes “Accessor”, which is a new component (node), and “a link from RecordSet to Accessor”, which is an associate (link) to a new component, as shown in FIG. 4B. Then, the new component and the associate which are not associated with the architecture model 20 are detected, and outputted as the gap information 7.

When the source code 5 is changed in maintenance operation of a software program in this manner, whether a structure of the changed software program is departing from an architecture defined in its specification or not can be known by the outputted gap information 7.

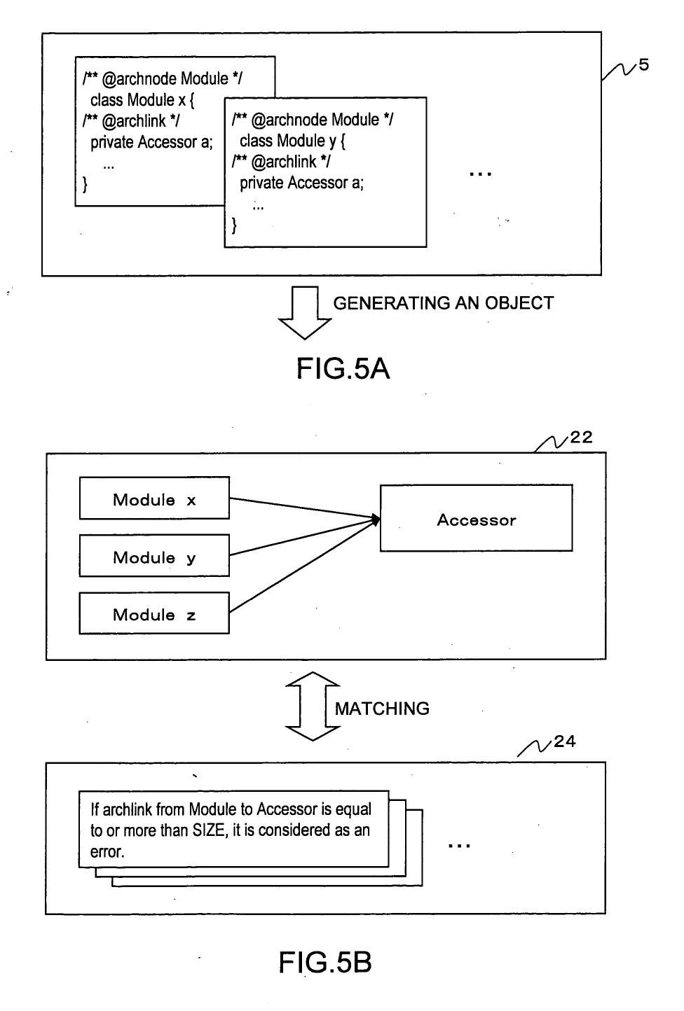

Next, processing of matching a source code with the bad pattern information 24 in the embodiment will be described by using FIGS. 5A and 5B. It is assumed that the bad pattern information storing unit 16 previously stores the bad pattern information 24 in which a predetermined bad pattern is described based on modeling representation of the UML.

The pattern matching unit 18 compares each piece of pattern information of the bad pattern information 24 and the source code structure model 22, and if the source code structure model 22 has a part corresponding to the bad pattern, detects the part, and outputs the part as the detected badness information 9. It is assumed that the source code model 22 of FIG. 5B is generated through the abovementioned processing from the source code 5 shown in FIG. 5A, for example. It is also assumed that a bad pattern such as “If archlink from Module to Accessor is equal to or more than SIZE, it is considered as an error.” is defined in the bad pattern information 24 as shown in FIG. 5B.

The pattern matching unit 18 extracts an associate which is “a link from Module to Accessor” in the source code structure model 22 and compares the number with SIZE. If SIZE=2 and three associates of “Module x→Accessor”, “Module y→Accesor”, and “Module z→Accessor” are extracted, an excess of the number of associates corresponds to the bad pattern of the bad pattern information 24. The pattern matching unit 18 outputs the associates as the detected badness information 9.

Therefore, if a source code is changed in software maintenance and even a configuration corresponding to a bad pattern is included in the source code 5, the detected badness information 9 can detect that configuration corresponding to a bad pattern.

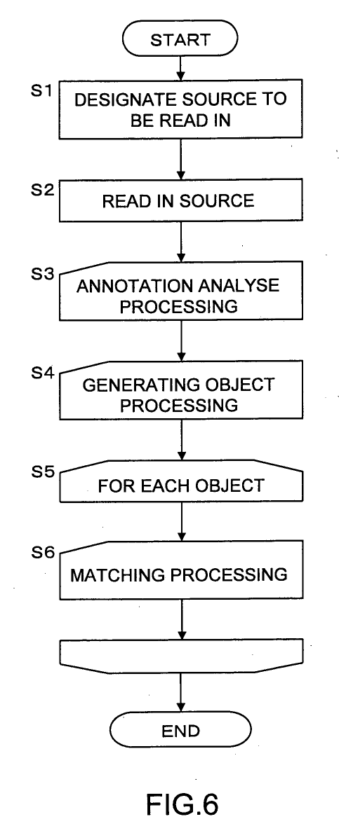

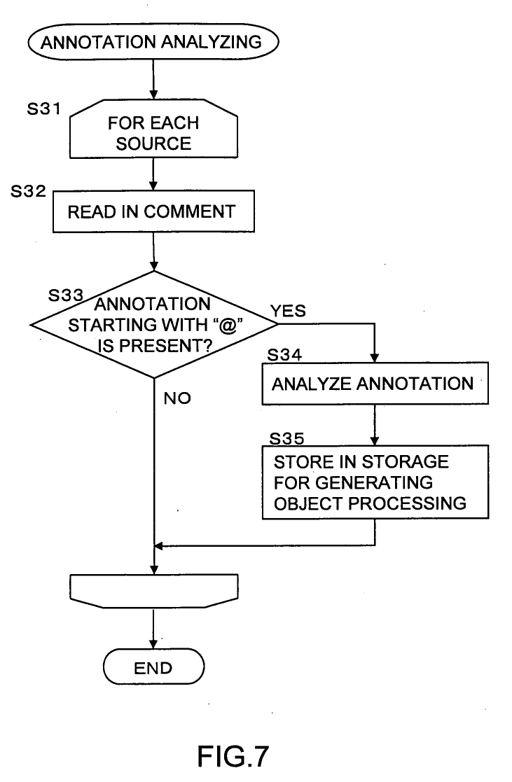

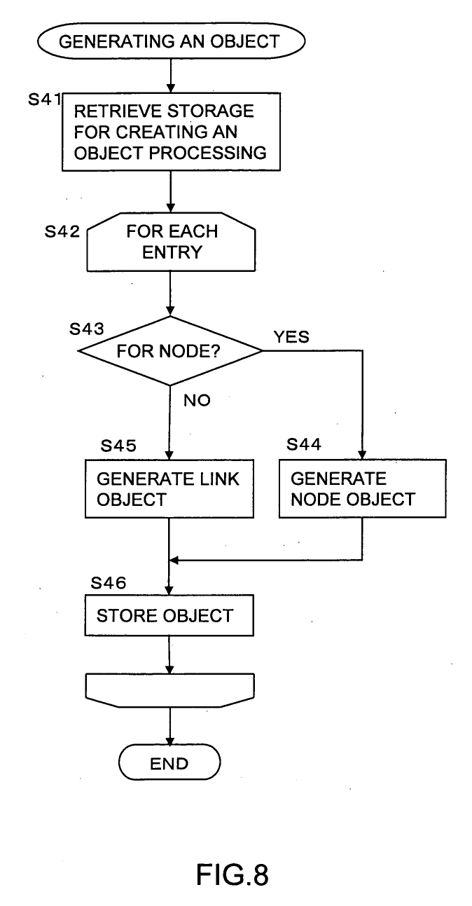

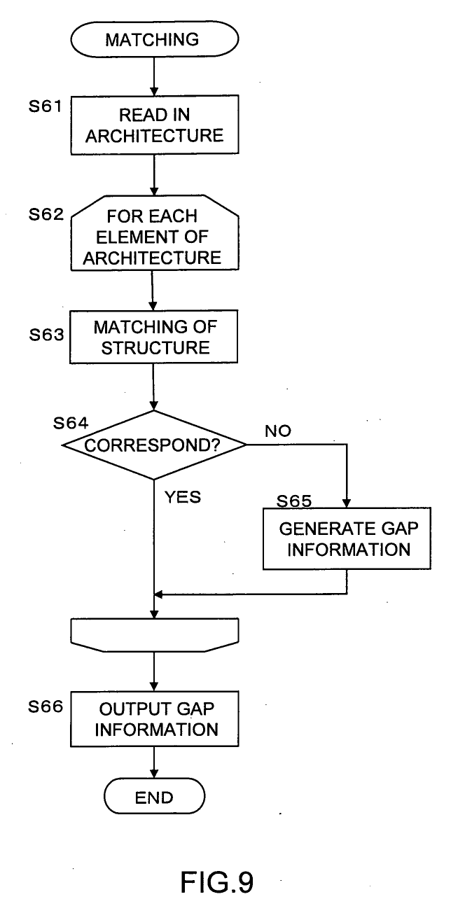

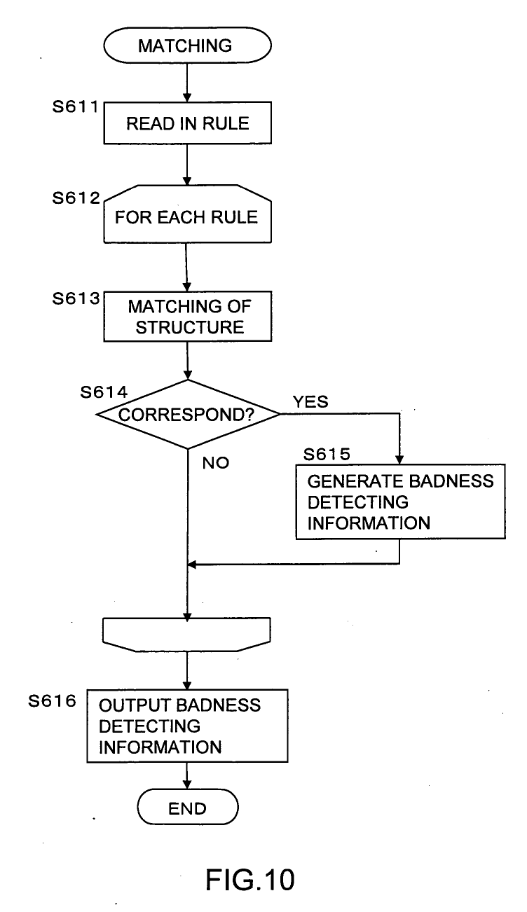

FIGS. 6 to 10 show processing flows of the present invention. FIG. 6 shows a processing flow of main processing of the present invention, FIG. 7 shows a processing flow of annotation analyzing processing, FIG. 8 shows a processing flow of rendering as an object processing, FIG. 9 shows a processing flow of matching for analyzing a gap against architecture information, and FIG. 10 is a processing flow of matching for matching a pattern against the bad pattern information 24.

In the processing flow of FIG. 6, when a user designates one or more source codes 5 of a software program to be read as an object of the processing (step S1), the annotation analyzing unit 121 reads the designated source code 5 (step S2) and executes the annotation analyzing (step S3).

FIG. 7 shows a processing flow of the annotation analyzing processing at the step S3. The annotation analyzing unit 121 executes each processing from the step S32 to the step S35 shown below for each source of the read source code 5 (step S31). First, the annotation analyzing unit 121 cuts out a comment, which is a character string in a predetermined notation such as being sandwiched between “/*” and “*/”, from the read source code 5 and reads it (step S32). It determines whether an annotation (comment) starting with “@” is in the read comment or not (step S33). If an annotation starting with “@” is in the comment (YES at step S33), the annotation analyzing unit 121 analyzes the annotation (step S34), and stores component information on the elements extracted by the analyzing processing (for example, a class name, a field name, a message name, a link destination, and the like) in storage for rendering as an object processing (step S35).

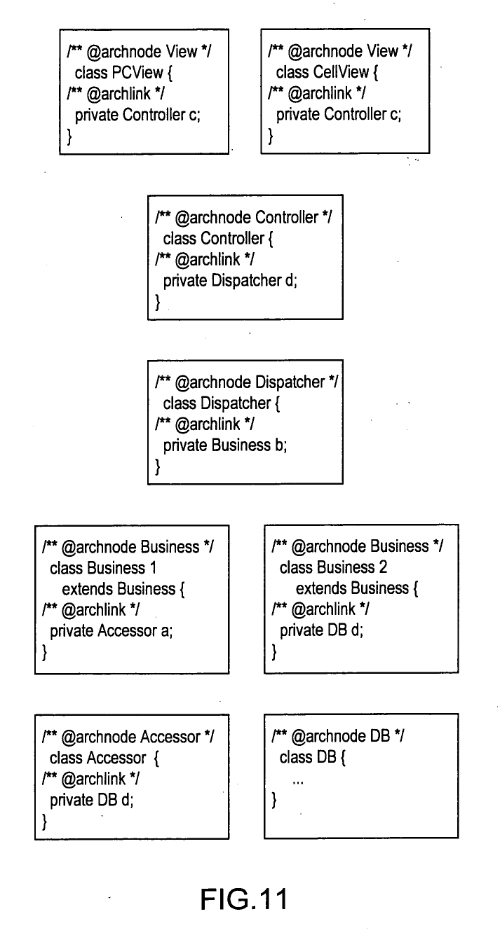

FIG. 11 shows an example of a comment part extracted from the source code 5. The annotation analyzing unit 121 detects annotations (comments) starting with “@” from the extracted comments and extracts predetermined elements from the annotation. The annotation analyzing unit 121 determines that the elements are node objects indicating the component from “@archnode” and extracts component information such as a class name “PCView”. It also determines that the elements are link objects indicating associates from “@archlink” and extracts component information such as a link destination of “Controller”.

Then, operation returns to the processing at the step S31, where the next source is read. Next, the processing from the step S32 to the step S35 is executed. If the abovementioned processing has been executed on all the sources, processing is returned.

Next, the generating object unit 123 executes rendering as an object processing (step S4 in FIG. 6). FIG. 8 shows a processing flow of rendering as an object processing at the step S4.

The generating object unit 123 retrieves storage for rendering as an object processing (step S41), and executes processing from the step S43 to the step S46 shown below on each entry in the retrieved arrangement (step S42). First, the generating object unit 123 determines whether the retrieved entry is for node or not (step S43). If the entry is for node (YES at step S43), the generating object unit 123 creates a node object based on component information such as a class name and a field name stored in the entry (step S44). If the entry is not for node (NO at step S43), the generating object unit 123 creates a link object based on component information such as a link destination stored in the entry (step S45). The created objects (a link object and a node object) are stored in the source code object storing unit 15 as the source code structure model 22 (step S46).

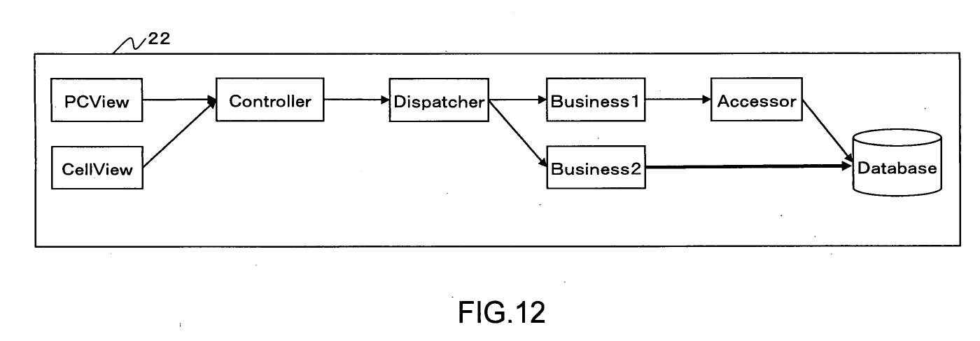

FIG. 12 shows the source code structure model 22 represented by node objects and link objects generated by the generating object unit 123. In FIG. 12, a rectangle represents a node object and an arrow represents a link object.

Then, operation returns to the processing at step S42, where the next entry is retrieved and the processing at steps from S43 to S46 is executed. If the processing has been executed on all the entries, processing is returned.

Next, the gap analyzing unit 14 repeats matching processing at step S6 on each object generated by the rendering as an object processing (step S5 in FIG. 6).

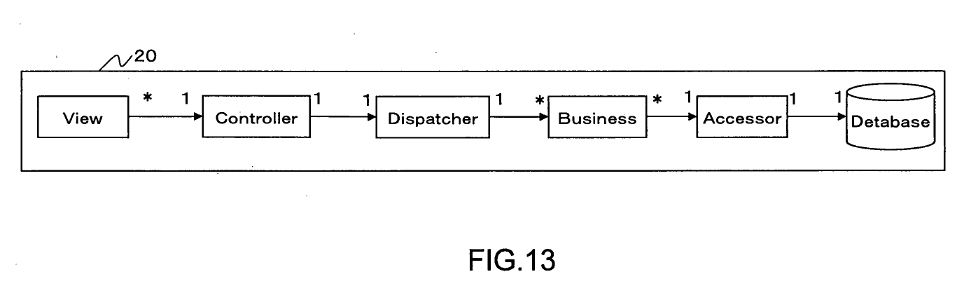

FIG. 9 shows a processing flow executed when a gap against the architecture information 3 is analyzed as the matching processing at the step 6. First, the architecture analyzing unit 101 reads the architecture information 3 of a software program (step S61). Here, as shown in FIG. 13, the architecture information 3 is assumed to be information on a software program structure which is rendered as an object among a specification material. The information is stored in the architecture object storing unit 13 as the architecture model 20.

If the architecture information 3 is not design information which is rendered as an object, the architecture analyzing unit 101 analyzes the read architecture information 3 and extracts information indicating elements and association between the elements from the design information. The generating object unit 103 generates an object from the extracted information.

The gap analyzing unit 14 executes each processing from the step S63 to the step S65 on each object element of the architecture model 20 in the architecture object storing unit 13 (step S62). The gap analyzing unit 14 executes matching to check whether an object (node object or link object) of the source structure model 22 corresponds to each object of the architecture model 20 or not (step S63). As a result of the matching, if the objects of the source structure model 22 do not correspond to any object of the architecture model 20 (NO at the step S64), the gap analyzing unit 14 generates the gap information 7 from information on the objects (step S65). On the other hand, as a result of the matching, if the objects of the source code structure model 22 correspond to any object of the architecture model 20 (YES at the step S64), the gap analyzing unit 14 does not generate the gap information 7. For example, node objects of the source code structure model 22 in FIG. 12 correspond to node objects of the architecture model 20 in FIG. 13. However, the link object from a subclass of the source code structure model 22 “Business2” to a class “Database” is not present in the link object of the architecture model 20, and the link object is not corresponding thereto. Therefore, the gap analyzing unit 14 detects the link object as non-corresponding and generates the gap information 7 based on information on the link object.

Then, operation returns to the processing at the step S62, where an object of the next source structure model 22 is read in and the processing from the step S63 to the step S65 is executed. If the processing has been done on all the objects, the generated gap information 7 is outputted (step S66) and processing is returned.

A processing flow of pattern matching against the bad pattern information 24 is executed as the matching processing at the step S6. FIG. 10 shows a processing flow of pattern matching against the bad pattern information 24 as the matching processing at the step S6.

The pattern matching unit 18 reads in the bad pattern information 24 from the bad pattern information storing unit 16 (step S611). Here, the bad pattern information 24 is assumed as a set of rules which is a configuration inappropriate as a software program rendered as an object. Processing from the step S613 to the step S615 shown below is executed on the objects representing each rule of the bad pattern information 24 (step S612). The pattern matching unit 18 executes matching to check whether a node object or a link object of the source code structure model 22 corresponds to the retrieved object of a rule or not (step S613). As a result of the matching, if an object of the source code structure model 22 corresponds to the retrieved object of a rule (YES at the step S614), the detected badness information 9 is generated based on corresponding information on the object of the source code structure model 22 (step S615). As a result of the matching, if the objects of the source code structure model 22 do not correspond to any of the retrieved objects of a rule (NO at the step S614), the pattern matching unit 18 does not generate the detected badness information 9.

Then, operation returns to the processing at the step S612, where the processing from the step S613 to the step S615 is executed for the next rule. If processing has been executed on objects of all the rules of the bad pattern information 24, the detected badness information 9 is outputted (step S616) and processing is returned.

Although the present invention has been described by using the embodiment, it is a matter of course that the present invention can be variously modified without departing from the spirit.

The program product realizing the present invention can be stored on an appropriate computer readable recording medium such as transportable medium memory, semiconductor memory or hard disk and provided on the recording medium, or can be provided by sending/receiving over various types of communication network via a communication interface.

What is claimed is:

1. A software maintenance supporting program product for causing a computer to execute processing of:
obtaining a source code of a software program with a predetermined annotation which designates elements comprised in the software program;
extracting elements comprised in said software program and associates indicating association between the elements based on the annotation of said source code;
generating a source code structure model representing said software program structure according to predetermined modeling representation based on said elements and said associates and storing said source code structure model in a source code structure model storing unit;
obtaining architecture information defining said software program structure;
generating an architecture model representing said software program structure according to said predetermined modeling representation based on said architecture information and storing the architecture model in an architecture model storing unit; and
comparing the elements and associates of said source code structure model with the elements and associates of said architecture model, and if the elements or the associates are not associated with each other in said source code structure model and said architecture model, detecting the elements and associates that are not associated with each other as gap information.

2. The software maintenance supporting program product according to claim 1, for causing said computer to execute processing of:
generating gap information based on information on the elements or the associates detected as said gap information in the processing of detecting the elements which are not associated for said source code structure model and said architecture model.

3. A software maintenance supporting program product for causing a computer to execute processing of:
obtaining bad pattern information representing elements inappropriate for comprising a software program by using elements representing a software program structure and associates indicating association between the elements;
obtaining a source code of the software program with a predetermined annotation which designates elements comprised in the software program;
extracting elements comprised in said software program and associates indicating association between the elements based on the annotation of said source code;
generating a source code structure model representing a structure of the software program represented by said source code according to predetermined modeling representation based on said elements and said associates and storing the source code structure model in a source code structure model storing unit; and
determining whether any of the elements and associates of said source code structure model correspond to said bad pattern information and detecting the elements or associates corresponding to the bad pattern information.

4. The software maintenance supporting program product according to claim 3 for causing said computer to execute processing of:
generating detected badness information based on information on the elements and associates detected to be corresponding to said bad pattern information in the processing of detecting the elements or the associates corresponding to said bad pattern information.

5. A software maintenance supporting method that is a processing method executed by a computer, comprising the steps of:
obtaining a source code of a software program with a predetermined annotation which designates elements comprised in the software program;
extracting elements comprised in said software program and associates indicating association between the elements based on the annotation of said source code;
generating a source code structure model representing said software program structure according to predetermined modeling representation based on said elements and said associates and storing said source code structure model in a source code structure model storing unit;
obtaining architecture information defining said software program structure;
generating an architecture model representing said software program structure according to said predetermined modeling representation based on said architecture information and storing the architecture model in an architecture model storing unit; and
comparing the elements and associates of said source code structure model with the elements and associates of said architecture model, and if the elements and associates are not associated with each other in said source code structure model and said architecture model, detecting the elements or the associates that are not associated with each other as gap information.

6. The software maintenance supporting method according to claim 5, comprising the processing step of:
generating gap information based on information on the elements or the associates detected as said gap information in the processing step of detecting the elements which are not associated for said source code structure model and said architecture model.

7. A software maintenance supporting method that is a processing method executed by a computer, comprising the steps of:
obtaining bad pattern information representing elements inappropriate for comprising a software program by using elements representing a software program structure and associates indicating association between the elements;
obtaining a source code of the software program with a predetermined annotation which designates elements comprised in the software program;
extracting elements comprised in said software program and associates between the elements based on the annotation of said source code;
generating a source code structure model representing a structure of the software program represented by said source code according to predetermined modeling representation based on said elements and said associates and storing the source code structure model in a source code structure model storing unit; and
determining whether any of the elements and associates of said source code structure model correspond to said bad pattern information and detecting the elements or the associates corresponding to the bad pattern information.

8. A software maintenance supporting method according to claim 7, further comprising the processing step of:
generating detected badness information based on information on the elements and associates detected to be corresponding to said bad pattern information in the processing step of detecting the elements or the associates corresponding to said bad pattern information.

9. A software maintenance supporting apparatus comprising:
a unit for obtaining a source code of a software program with a predetermined annotation which designates elements comprised in the software program;
a unit for extracting elements comprised in said software program and associates indicating association between the elements based on the annotation of said source code;
a unit for generating a source code structure model representing said software program structure according to predetermined modeling representation based on said elements and said associates;
a storage unit for storing said source code structure model;
processing means for obtaining architecture information defining said software program structure;
a unit for generating an architecture model representing said software program structure according to said predetermined modeling representation based on said architecture information;
a storage unit for storing said architecture model; and
a unit for comparing the elements or the associates of said source code structure model and the elements or the associates of said architecture model, and if the elements or the associates are not associated with each other in said source code structure model and said architecture model, detecting the elements or the associates that are not associated with each other as gap information.

10. The software maintenance supporting apparatus according to claim 9 wherein
the unit for detecting the elements which are not associated for said source code structure model and said architecture model generates gap information based on information on the elements or the associates detected as said gap information.

11. A software maintenance supporting apparatus comprising:
a storage unit for storing bad pattern information representing elements inappropriate for comprising a software program by using elements representing a software program structure and associates indicating association between the elements;
a unit for obtaining a source code of the software program with a predetermined annotation which designates elements comprised in the software program;
a unit for extracting elements comprised in said software program and associates indicating association between the elements based on the annotation of said source code;
a unit for generating a source code structure model representing a structure of the software program represented by said source code according to predetermined modeling representation based on said elements and said associates;
a storage unit for storing said source code structure model; and
processing means for determining whether the elements and associates of said source code structure model correspond to said bad pattern information and detecting the elements or associates corresponding to the bad pattern information.

12. The software maintenance supporting apparatus according to claim 11 wherein
the unit for detecting the elements or the associates corresponding to said bad pattern information generates detected badness information based on information on the elements or the associates detected to be corresponding to said bad pattern information.
